(19) United States
(12) Patent Application Publication
(10) Pub. No.: US 2005/0004792 A1
(43) Pub. Date: Jan. 6, 2005

(54) Speech characteristic extraction method speech charateristic extraction device speech recognition method and speech recognition device

(76) Inventors: Yoichi Ando, Kagoshima (JP); Kenji Fujii, Hyogo (JP)

Correspondence Address: BIRCH STEWART KOLASCH & BIRCH, PO BOX 747, FALLS CHURCH, VA, 22040-0747, US

(21) Appl. No.: 10/496,673

(22) PCT Filed: Dec. 12, 2002
(86) PCT No.: PCT/JP02/13041

(30) Foreign Application Priority Data
Dec. 13, 2001 (JP) 2001379860

(51) Int. Cl. G10L 19/00

(52) U.S. Cl. 704/217

(57) ABSTRACT

Speech characteristics are obtained using a minimum of parameters, which correspond to auditory perception characteristics, without carrying out spectral analysis, by determining an ACF (autocorrelation function) of a speech signal collected by a microphone, and deriving from the ACF a value Φ (0) of when a delay time of the ACF is 0, a delay time τ₁ and an amplitude φ₁ of a first peak of the ACF, and an effective duration time τₑ of the ACF. Furthermore, it is possible to achieve highly accurate recognition that reflects human perception in actual sound fields by determining an interaural crosscorrelation function (IACF) of the speech signal, and extracting from the IACF a maximum value IACC of the IACF, a delay time τ_{IACC} of a peak of the IACF, and a width W_{IACC} of the maximum amplitude of the IACF, and including these IACF factors, that is, spatial information of the sound field.

### TECHNICAL FIELD

The present invention relates to technologies used in the field of speech recognition, in particular, to speech characteristic extraction methods and speech characteristic extraction devices optimized for extracting speech characteristics in actual sound fields and to speech recognition methods and speech recognition devices using the same.

### BACKGROUND ART

A predominant method in speech recognition technologies is to obtain a feature vector of a speech signal by analyzing an input speech signal for overlapping short-period analysis segments (frames) in a fixed time interval, and to perform speech matching based on time-domain signal of the feature vector.

Many methods have been offered for analyzing these feature vectors, with typical methods including cepstral analysis and spectral analysis.

Incidentally, although the various analytical methods such as cepstral analysis and spectral analysis are different in their details, ultimately they all focus on the issue of how to estimate speech signal spectra. And although these methods are potentially effective due to the fact that speech signal features are evident in the structure of the spectra, they have the following problems:

(1) Since speech signals include wide ranging frequency information, complex parameters are required to reproduce their spectra. Also, many of these parameters are not substantially important in terms of auditory perception and can thus become a cause of prediction errors.

(2) Conventional analytical methods have problems involving poor handling of noise, and there are limitations in analyzing spectra that have widely varying patterns due to background noise and reverberations.

(3) In order to achieve speech recognition in actual environments, it is necessary to deal with such particulars as the movement of speakers and multiple sources of sound typified by the so-called “cocktail party effect,” but little consideration is given in conventional analytical methods to the spatial information of such acoustic fields, and consequently difficulties are faced in performing speech characteristic extraction that reflects human auditory perception in actual sound fields.

### DISCLOSURE OF INVENTION

The present invention has been devised to solve these issues, and it is an object therein to provide a speech characteristic extraction method and a speech characteristic extraction device that can extract speech characteristics in actual sound fields using a minimum of parameters, which correspond to human auditory perception characteristics, without carrying out spectral analysis, as well as to provide a speech recognition method and a speech recognition device that use such a extraction method and device.

Firstly, the present applicants/inventors discovered through research that important information related to speech characteristics is contained in the autocorrelation function of speech signals. Specifically, the following factors were found: the factor that the value Φ (0) when the delay time of an autocorrelation function is 0 expresses the volume of a sound, the factor that a delay time τ₁ and an amplitude φ₁ of a first peak of an autocorrelation function express a frequency corresponding to the pitch (sound pitch) of a speech and the intensity of that pitch, and the factor that an effective duration time τₑ of an autocorrelation function expresses a repetition component and a reverberation component contained in the signal itself. Furthermore, the factor that local peaks that appear up to a first peak of an autocorrelation function contain information related to timbre was also found (discussed in further detail later).

Furthermore, it was discovered that important information related to spatial characteristics of directional position, a sense of expansiveness, and sound source width is contained in the interaural crosscorrelation function of a binaurally measured speech signal. Specifically, the following factors were found: the factor that a maximum value IACC of the interaural crosscorrelation function is related to subjective dispersion, the important factor that a delay time τ_{IACC} of a peak of the interaural crosscorrelation function is related to the perception of the horizontal direction of the sound source, and, moreover, the factor that the maximum value IACC of the interaural crosscorrelation function and the width W_{IACC} of a maximum amplitude of the interaural crosscorrelation function are related to the perception of the apparent source width (ASW) (discussed in further detail later).

Focusing on these points, the present invention achieves a speech characteristic extraction method and a speech characteristic extraction device, as well as a speech recognition method and a speech recognition device that, without carrying out spectral analysis, are able to extract speech characteristics in actual sound fields by using a minimum of parameters that correspond to the factors contained in the autocorrelation function and the interaural crosscorrelation function, that is, that correspond to human auditory perception characteristics. Specific configurations of these are as follows.

A speech characteristic extraction method according to the present invention extracts a speech characteristic required for speech recognition, wherein an autocorrelation function of a speech signal is determined, and a value Φ (0) of when a delay time of the autocorrelation function is 0, a delay time τ₁ and an amplitude φ₁ of a first peak of the autocorrelation function, and an effective duration time τₑ of the autocorrelation function are extracted from the autocorrelation function. The speech characteristic extraction method of the present invention may also be configured so that, in addition to the above-noted speech characteristic quantities, local peaks up to the first peak of the autocorrelation function are extracted.

A speech characteristic extraction device according to the present invention extracts a speech characteristic required for speech recognition, and is provided with a microphone; a computing means for obtaining an autocorrelation function of a speech signal collected by the microphone; and a extraction means for extracting from the autocorrelation function a value Φ (0) of when a delay time of the autocorrelation function is 0, a delay time τ₁ and an amplitude φ₁ of a first peak of the autocorrelation function, and an effective duration time τₑ of the autocorrelation function.

The speech characteristic extraction device of the present invention may also be configured so that, in addition to the above-noted speech characteristic quantities, local peaks up to the first peak of the autocorrelation function are extracted.

In a speech recognition method according to the present invention, data extracted by the above-mentioned speech characteristic extraction method, namely a value Φ (0) of when a delay time of the autocorrelation function is 0, a delay time τ₁ and an amplitude φ₁ of a first peak of the autocorrelation function, and an effective duration time τₑ of the autocorrelation function, are compared to a template for speech recognition to achieve speech recognition.

The speech recognition method of the present invention may also be configured so that, in addition to the above-noted speech characteristic quantities, local peaks up to a first peak of the autocorrelation function are extracted, and data including the local peaks are compared to a template to achieve speech recognition.

A speech recognition device according to the present invention is provided with the above-mentioned speech characteristic extraction device; and a recognition means for recognizing a speech, wherein data extracted by the speech extraction device, namely a value Φ (0) of when a delay time of the autocorrelation function is 0, a delay time τ₁ and an amplitude φ₁ of a first peak of the autocorrelation function, and an effective duration time τₑ of the autocorrelation function, are compared to a template for speech recognition to achieve speech recognition.

The speech recognition device of the present invention may also be configured so that, in addition to the above-noted speech characteristic quantities, local peaks up to a first peak of the autocorrelation function are extracted, and data including the local peaks are compared to a template to achieve speech recognition.

A speech characteristic extraction method of the present invention extracts a speech characteristic required for speech recognition, wherein: an autocorrelation function and an interaural crosscorrelation function of a binaurally measured speech signal are respectively obtained, and a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function of the speech signal, and a value Φ (0) of when a delay time of the autocorrelation function, or the interaural crosscorrelation function, is 0, are extracted from the autocorrelation function and the interaural crosscorrelation function.

The speech characteristic extraction device of the present invention may also be configured so that, in addition to the above-noted speech characteristic quantities, local peaks up to a first peak of the autocorrelation function are extracted.

A speech characteristic extraction device of the present invention extracts a speech characteristic required for speech recognition, and is provided with: a binaural microphone; a computing means for respectively obtaining an autocorrelation function and an interaural crosscorrelation function of a speech signal collected by the microphone; and a extraction means for extracting from the autocorrelation function and the interaural crosscorrelation function a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function, and a value Φ (0) of when a delay time of the autocorrelation function, or the interaural crosscorrelation function, is 0, are extracted.

The speech characteristic extraction device of the present invention may also be configured so that, in addition to the above-noted speech characteristic quantities, local peaks up to a first peak of the autocorrelation function are extracted.

In a speech recognition method of the present invention, data extracted by the speech characteristic extraction method, namely a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function of the speech signal, and a value Φ (0) of when a delay time of the autocorrelation function, or the interaural crosscorrelation function, is 0, are compared to a template for speech recognition to achieve speech recognition.

The speech characteristic extraction device of the present invention may also be configured so that, in addition to the above-noted speech characteristic quantities, local peaks up to a first peak of the autocorrelation function are extracted, and data including the local peaks are compared to a template to achieve speech recognition.

A speech recognition device according to the present invention is provided with the above-mentioned speech characteristic extraction device, a recognition means for recognizing a speech, wherein data extracted by the speech extraction device, namely a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function, and a value Φ (0) of when a delay time of the autocorrelation function, or the interaural crosscorrelation function, is 0, are compared to a template for speech recognition to achieve speech recognition.

The speech characteristic extraction device of the present invention may also be configured so that, in addition to the above-noted speech characteristic quantities, local peaks up to a first peak of the autocorrelation function are extracted, and data including the local peaks are compared to a template to achieve speech recognition.

The template for speech recognition used here in the present invention is, for example, a set of autocorrelation function characteristic amounts (ACF factors) that are calculated in advance and related to an entire syllabary. Furthermore, a set of interaural crosscorrelation function characteristic amounts (IACF factors) that are calculated in advance may also be included in the template.

The following is a detailed description of the present invention.

First, a method of analyzing speech signals used in the present invention is described.

The method of analyzing speech signals in the present invention is based on the model of human auditory functions shown in FIG. 1. This model is constituted by neural mechanisms that measure the ACF of the left and right routes respectively, and the interaural IACF, with consideration given to processing characteristics of the left and right cerebral hemispheres.

In FIG. 1, r₀ is defined as the three dimensional spatial position of a sound source p(t), and r is defined as the center position of the head of a listener. h_{r,l(r/r}₀,t) is the impulse response between r₀ and the left and right external canal entrances. The impulse responses of the external canals and the ossicular chains are respectively expressed e_{l,r} (t) and c_{l,r} (t). The velocity of the basilar membrane is expressed V_{l,r} (x,ω).

The effectiveness of ACF and IACF models such as these has been proven in research related to the perception of the fundamental attributes of sound sources and subjective evaluations of sound fields including preferences. (See Y Ando (1998), Architectural Acoustics: Blending Sound Sources, Sound Fields, and Listeners AIP Press/Springer-Verlag, New York.)

Moreover, according to recent research in the field of physiology, it has been found that auditory neural firing patterns show close similarities to the ACF of the input signal, and the existence of an ACF model in neural mechanisms is becoming evident. (See P. A. Cariani (1996), Neural correlates of the pitch of complex tones. I. Pitch and Pitch Salience, Journal of Neurophysiology, 76, 3, 1698-1716.)

With factors extracted from the ACF, it is possible to evaluate the fundamental attributes of sound, including loudness (size of sound), pitch (height of sound), and timbre. And with factors extracted from the IACF, it is possible to evaluate a sense of expansiveness, which is a spatial characteristic of a sound field, directional position, and width of a sound source.

In a sound field, the ACF of a sound source signal that reaches a human ear can be obtained from the following formula.

$${Φ}_{p} ( τ ) = {lim}_{T -> ∞} \frac{1}{2 T} {\int }_{- T}^{T} {p}^{′} ( t ) {p}^{′} ( t + τ ) ⅆ t \qquad ( 1 )$$

Here p′(t)=p(t)*s(t), and s(t) is the sensitivity of the ear. Usually the impulse response of A characteristics are used for s(t). A power spectrum of the sound source signal can also be obtained from the ACF with the following formula.

$${P}_{d} ( ω ) = {\int }_{- ∞}^{∞} {Φ}_{p} ( τ ) {ⅇ}^{- j w π} ⅆ t \qquad ( 2 )$$

In this way, the ACF and the power spectrum contain the same information mathematically.

One of the important qualities of an ACF is that the maximum value is held at the time when the delay time τ=0 in the formula (1). This value is defined as Φ□ (0). Φ (0) expresses the energy of the signal, and therefore the normalized ACF (φ(τ) excluding this value is usually used in signal analysis. Furthermore, by obtaining the geometrical mean of the left and right Φ□ (0) and performing a base-ten logarithmic conversion, it is possible to obtain the relative listening level LL at the position of the head. The effective duration time τₑ, which is defined by the envelope of the normalized ACF, is the most important factor (characteristic amount) that has been overlooked in ACF analysis up until now.

As shown in FIG. 5, the effective duration time τₑ is defined as a 10 percent delay time and expresses repetitive components and reverberation components contained in the signal itself. Furthermore, the fine structure of the ACF, which contains peaks and dips, contains a plentitude of information related to the cyclic properties of the signal. Information related to pitch is the most effective for analyzing speech signals, and the delay time τ₁ and the amplitude φ₁ of the first peak of the ACF (FIG. 6) have factors that express the number of cycles relative to speech pitch and the intensity thereof.

The first peak here is often the maximum peak of the ACF and peaks appear periodically with that cycle. Furthermore, the local peaks that appear in the time up to the first peak express a time structure of the high frequency area of the signal, and therefore contain information related to timbre. In particular, in the case of speech, the represent characteristics of the resonance frequency of the vocal tract, also called a formant. The above-described ACF factors contain all the speech characteristics necessary for recognition.

That is to say, a speech can be specified with the delay time and the amplitude of the first peak of the ACF, which correspond to pitch and pitch intensity, and ACF local peaks, which correspond to the formant, and consideration can be given to the influence of noise and reverberation in actual sound fields with the effective duration time effective duration time τₑ.

The following is a description of IACF.

A long-term IACF can be obtained by the following formula.

$${Φ}_{lr} ( τ ) = {lim}_{T -> ∞} \frac{1}{2 T} {\int }_{- T}^{T} {p}_{l}^{′} ( t ) {p}_{r}^{′} ( t + τ ) ⅆ t \qquad ( 3 )$$

Here, p′_{l,r} (t)=pₗᵣ (t)*s(t), which is the sound pressure at the entrances of the left and right external canals. Spatial information, which includes perception of the horizontal direction of the sound source, is expressed by the following formula.
S=f(LL, IACC,τ_{IACC}, W_{IACC}) (4)

Here, the following definitions apply.
LL=10 log[Φₗₗ(0)Φᵣᵣ(0)]^{1/2} (5)
IACC=|φₗᵣ(τ)|ₘₐₓ,|τ|≦1 ms (6)

τ W_{IACC} and W_{IACC} are defined as shown in FIG. 7, and are the delay time and width of the IACF peak. Among the IACC factors, the τ_{IACC} within the range of −1 ms to +1 ms is an important factor related to the perception of the horizontal direction of the sound source.

When the IACC, which is the maximum value of the IACF, has a large value and the normalized IACF has one sharp peak, a distinct sense of direction can be obtained. When the τ_{IACC} has a negative value, the direction is to the left of the listener, and when it has a positive value, the direction is to the right of the listener. Conversely, when the IACC has a low value, the sense of subjective expansiveness is strong, and the sense of direction is indistinct. The perception of the apparent source width can be obtained with the IACC and W_{IACC}.

As described above, in regard to speech signals, by extracting a value Φ (0) of when a delay time of the ACF is 0, a delay time τ₁ and an amplitude φ₁ of a first peak of the ACF, and an effective duration time τₑ of the ACF, it is possible to obtain the size of the sound from the Φ (0) of the extracted ACF, and it is also possible to obtain the pitch of the sound (sound height) and the intensity thereof from the delay time τ₁ and the amplitude φ₁ of the first peak of the ACF. Furthermore, it is possible to give consideration to the influence of noise and reverberations in the actual sound field with the effective duration time τₑ of the ACF.

Moreover, by extracting the local peaks that appear up to the first peak of the ACF of the speech signal, it also possible to specify the timbre of the speech from the local peaks.

Furthermore, in regard to the speech signal, by extracting a maximum value IACC of the IACF, a delay time τ_{IACC} of a peak of the IACF, and a width W_{IACC} of the maximum amplitude of the IACF, it is possible to obtain a sense of subjective expansiveness, from the maximum value IACC of the IACF, and perception of the horizontal direction of the sound source can be obtained from the delay time τ_{IACC} of the peak of the IACF. Moreover, it is possible to obtain a perceived apparent source width (ASW) from the IACF maximum value IACC and the width W_{IACC} of the maximum amplitude of the IACF.

Accordingly, it is possible to achieve highly accurate recognition that reflects human perception in actual sound fields by including these IACF factors with speech recognition, that is, by including spatial information of the sound field.

In the present invention it is not necessary to extract all the above-described ACF factors and IACF factors. Of these factors, with at least the following four factors, namely the value Φ (0) when the delay time of the ACF is 0, the delay time τ₁ and the amplitude φ₁ of the first peak of the ACF, and the effective duration time τₑ of the ACF, it is possible to extract speech characteristics and carry out reliable speech recognition.

### BRIEF DESCRIPTION OF DRAWINGS

FIG. 1 is a block diagram showing an auditory function model.

FIG. 2 is a block diagram showing a configuration of an embodiment of the present invention.

FIG. 3 is a flowchart for a method of carrying out speech characteristic extraction and speech recognition according to the present invention.

FIG. 4 is a conceptual diagram for describing a method of calculating a running ACF and IACF.

FIG. 5 is a graph in which a logarithm of the absolute values of a normalized ACF is shown on the vertical axis, and the delay time is shown on the horizontal axis.

FIG. 6 is a graph in which a normalized ACF is shown on the vertical axis, and the delay time is shown on the horizontal axis.

FIG. 7 is a graph in which a normalized IACF is shown on the vertical axis, and the delay times of the left and right signals are shown on the horizontal axis.

FIG. 8 shows the estimation results of speech articulation in an actual environment.

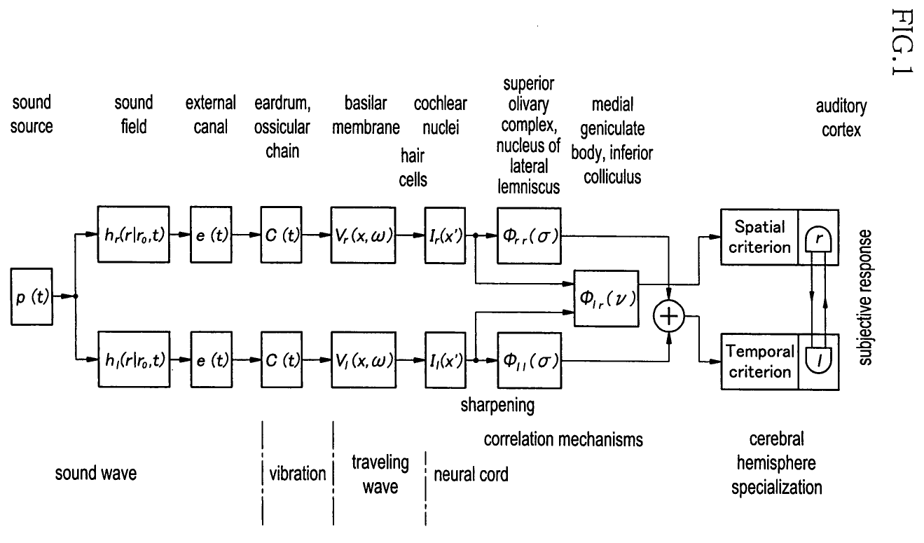

### BEST MODE FOR CARRYING OUT THE INVENTION

Hereinafter, embodiments of the invention are described with reference to the appended drawings.

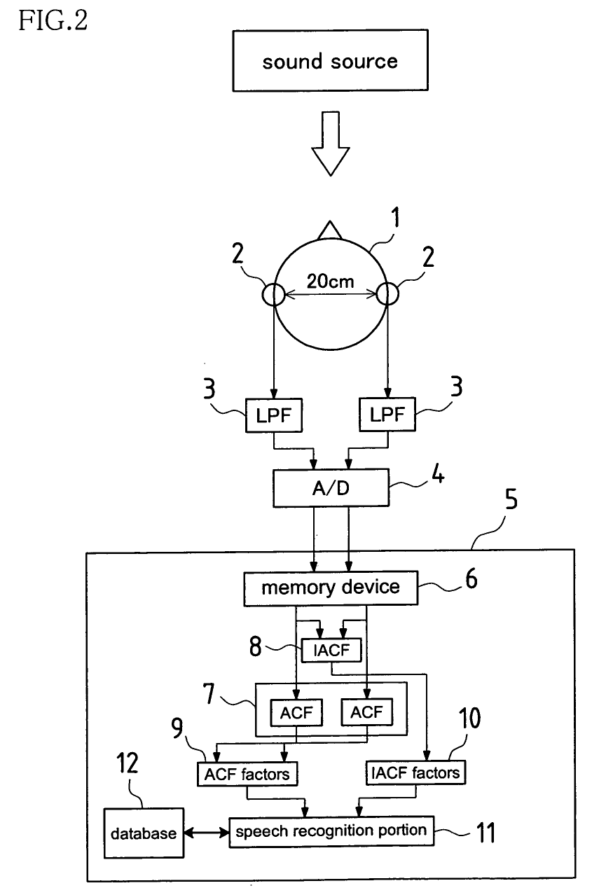

FIG. 2 is a block diagram showing a configuration of an embodiment of the present invention.

The speech recognition device shown in FIG. 2 is mainly constituted by binaural microphones 2 that are mounted on a listener's head model 1, low-pass filters (LPF) 3 that apply an A characteristic filter to speech signals collected by the microphones 2, an A/D converter 4, and a computer 5. It should be noted that the term A characteristic filter refers to a filter that corresponds to aural sensitivity s (t).

The computer 5 is provided with a memory device 6, an ACF computing portion 7, an IACF computing portion 8, an ACF factor extracting portion 9, an IACF factor extracting portion 10, a speech recognition portion 11, and a database 12.

The memory device 6 stores the speech signals collected by the binaural microphones 2.

The ACF computing portion 7 reads out the speech signals (two channels, left and right) stored in the memory device 6 and calculates an ACF (autocorrelation function). The calculation process will be discussed in detail later.

The IACF computing portion 8 reads out the speech signals stored in the memory device 6 and calculates an IACF (interaural crosscorrelation function). The calculation process will be discussed in detail later.

The ACF factor extracting portion 9 derives ACF factors from the ACF calculated by the ACF computing portion 7, including a value Φ (0) when the delay time of the ACF is 0, a delay time τ₁ and an amplitude φ₁ of a first peak of the ACF, and an effective duration time τₑ of the ACF. Furthermore, it derives local peaks up to the first peak of the ACF (shown in FIG. 6 as (τ′₁, φ′₁), (τ′₂, φ′₂), . . . ) The calculation process will be discussed in detail later.

The IACF factor extracting portion 10 derives IACF factors from the IACF calculated by the IACF computing portion 8, including a maximum value IACC of the IACF, a delay time τ_{IACC} of a peak of the IACF, and a width W_{IACC} of a maximum amplitude of the IACF. The calculation process will be discussed in detail later.

The speech recognition portion 11 recognizes (identifies) syllables by comparing the ACF factors and IACF factors, which were obtained from the speech signals in the above-mentioned processes, with a speech recognition template stored in the database 12. The syllable recognition process will be discussed in detail later.

The template stored in the database 12 is a set of ACF factors calculated in advance related to an entire syllabary. The template also contains a set of IACF factors that are calculated in advance.

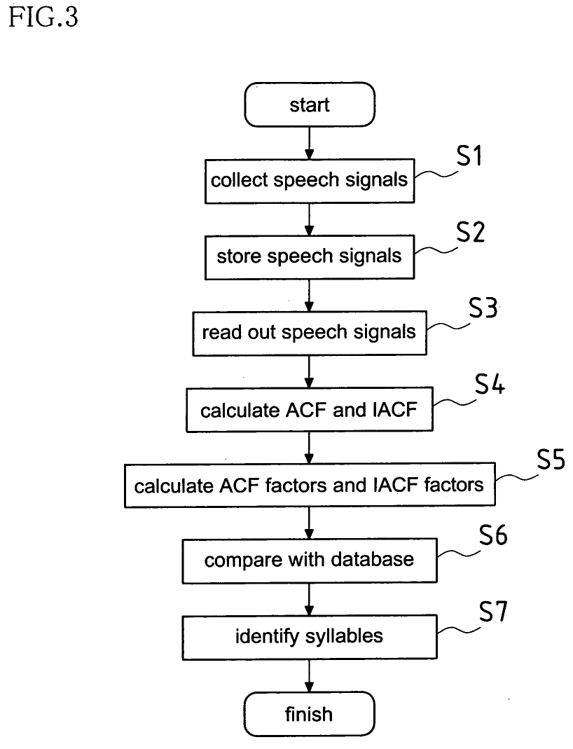

The following is a description of the operation of a syllable specifying process that is executed in the present embodiment with reference to the flowchart shown in FIG. 3.

First, speech signals are collected with the binaural microphones 2 (step S1). The collected speech signals are fed through the low-pass filters 3 to the A/D converter and converted to digital signals, and the post-digital conversion speech signals are stored in the memory device 6 in the computer 5 (step S2).

The ACF computing portion 7 and the IACF computing portion 8 read out the speech signals (digital signals) that are stored in the memory device 6 (step S3), and then respectively calculate the ACF and the IACF of the speech signals (step S4).

The calculated ACF and IACF are respectively supplied to the ACF factor extracting portion 9 and the IACF factor extracting portion 9 and ACF factors and IACF factors are calculated (step S5).

Then, the speech signal ACF factors and IACF factors obtained in the above-mentioned process are compared with a template that is stored in the database 12, and syllables are recognized (identified) by a process that will be discussed later (steps S6 and S7).

Here, with the device configuration shown in FIG. 2, it is possible to achieve a speech characteristic extraction device for extracting ACF factors and IACF factors by combining the head model 1, the binaural microphones 2, the low-pass filters 3, and the A/D converter 4, as well as the memory device 6, the ACF computing portion 7, the IACF computing portion 8, the ACF factor extracting portion 9, and the IACF factor extracting portion 10 of the computer 5.

Furthermore, it is possible to achieve a speech characteristic extraction device for extracting ACF factors by combining the head model 1, the binaural microphones 2, the low-pass filters 3, and the AVD converter 4, as well as the memory device 6, the ACF computing portion 7, and the ACF factor extracting portion 9 of the computer 5.

The following is a description of specific ACF and IACF calculation methods.

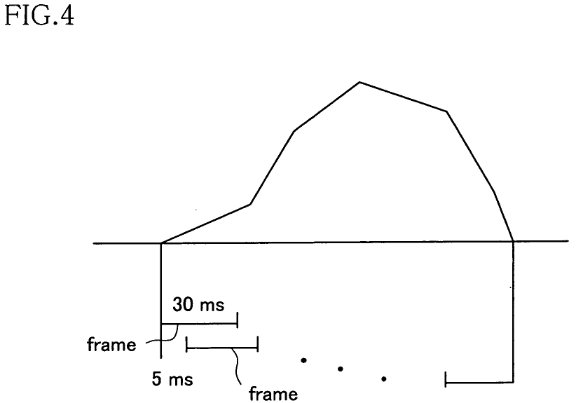

As shown in FIG. 4, running ACF and running IACF are calculated for short-period segments (hereafter “frames”) Fₖ (t) within the continuous time of the target speech signals. This method is chosen because speech signals characteristics vary over time. An ACF integral section 2T is designated as 20 to 40 times the minimum value of τₑ [ms] extracted from the ACF.

A frame length of several milliseconds to several tens of milliseconds is employed when analyzing speech, and adjacent frames are set to be mutually overlapping. In this embodiment, the frame length is set at 30 ms, with the frames overlapping every 5 ms.

A short-time running ACF, which is a function of the delay time τ, is calculated as follows:

$$\begin{matrix}{ϕ}_{p} ( τ ; t , T ) = \frac{{Φ}_{p} ( τ ; t , T )}{{[ {Φ}_{p} ( 0 ; t , T ) {Φ}_{p} ( τ + t , T ) ]}^{1 / 2}} \\ \text{Where:} & ( 7 ) \\ {Φ}_{p} ( τ ; t , T ) = \frac{1}{2 T} {\int }_{t - T}^{t + T} {p}^{′} ( t ) {p}^{′} ( t + τ ) ⅆ t & ( 8 )\end{matrix}$$

In formula (8), p′(t) indicates a signal that is the result of the A characteristic filter being applied to the collected speech signals p (t).

In the denominator of formula (7), Φ (0) is the ACF value when the delay time τ=0 and expresses the mean energy in the frames of the collected speech signals. As the ACF has its maximum value for a delay time of τ=0, an ACF that is normalized in this way holds a maximum value of 1 when τ=0.

When the ACF for the signals collected at the left and right ear positions Φ (0) are respectively expressed as Φₗₗ (τ) and Φᵣᵣ (τ), the binaural sound pressure level (SPL) at the position of the head portion is obtained by the following formula:
SPL=10log₁₀\sqrt{Φₗₗ(0)Φᵣᵣ(0)}−10log₁₀Φ_{ref}(0)=LL−10log₁₀Φ_{ref}(0) (9)

φ_{ref(}0) is the Φ (0) for a standard sound pressure value of 20 μP.

Factors necessary for syllable recognition are derived from the thus-calculated ACF. The following is a description of the definitions of these factors and methods for deriving the factors.

The effective duration time τₑ is defined as the delay time τ when the amplitude of the normalized ACF decays to 0.1.

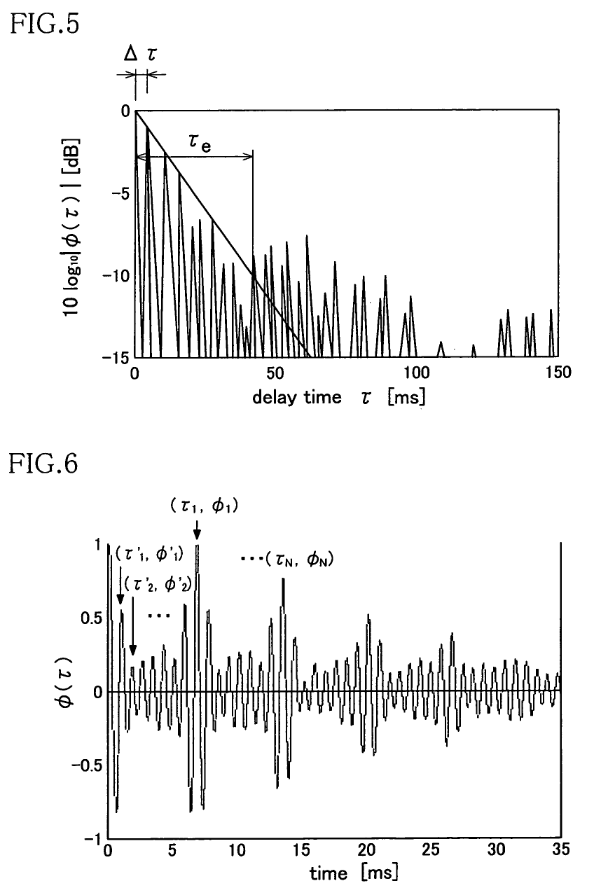

FIG. 5 is a graph showing the absolute value of the ACF as a logarithm on the vertical axis. As this linear attenuation in the initial ACF is generally observed, τₑ can be readily determined by linear regression. Specifically, τₑ is determined using a lowest mean square (LMS) method for the ACF peaks obtained in a certain fixed period Δτ.

FIG. 6 shows a calculation example of normalized ACF. Here, the highest peak of the normalized ACF is obtained, and the delay time and amplitude thereof are respectively defined as τ₁ and φ₁. Furthermore, local peaks up to the highest peak are obtained, and the delay times and amplitudes thereof are respectively defined as τ′ₖ and φ′ₖ where k=1, 2, . . . I.

The section in which peaks are obtained is the section from the delay time τ=0 until the appearance of the highest peak of the ACF, and this section corresponds to one cycle of ACF. As noted above, the highest peak of the ACF corresponds to the pitch of the sound source, and the local peaks up to the highest peak correspond to formants.

The following is a description of a method for calculating the IACF and the factors that can be derived from such a calculation.

The IACF is defined by the following formula:

$${Φ}_{lr} ( τ ; t , T ) = \frac{1}{2 T} {\int }_{t - T}^{t + T} {p}_{l}^{′} ( t ) {p}_{r}^{′} ( t + τ ) ⅆ t \qquad ( 10 )$$

Here the subscripts l and r indicate the signals that arrive at the left and right ears.

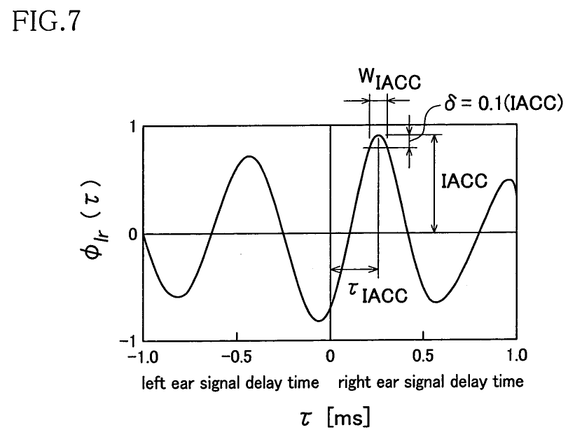

FIG. 7 shows an example of a normalized IACF. It is sufficient to consider the maximum delay time between both ears as from −1 ms to +1 ms. The IACC for the maximum amplitude of the IACF is a factor that relates to subjective dispersion.

Next, the value of τ_{IACC} is a factor that expresses the arrival direction of the sound source. For example, when τ_{IACC} takes on a positive value, the sound source is perceived as being positioned to the right of the listener or the sound source is perceived as being present to the right of the listener. When τ_{IACC}=0, it means that the sound source is perceived as being directly in front of the listener.

Furthermore, the width W_{IACC} of the maximum amplitude is defined as the width between the locations that are 0.1 lower than the maximum value. The coefficient 0.1 is a value obtained through experimentation and is used as an approximation.

The following is a description of a method for recognizing syllables based on inter-syllable distances between the input signal and the template.

The inter-syllable distance is a calculation of the distance between the ACF factors and IACF factors obtained for the collected speech signals and the template stored in the database. The template is a set of ACF factors calculated in advance that are related to an entire syllabary. Since the ACF factors express perceived sound characteristics, this method uses the fact that if speeches resemble each other in terms of auditory perception, then naturally the factors obtained from those speeches will also resemble each other.

The distance D (x) (x: Φ (0), τₑ, τₖ, φₖ, τ′ₖ, φ′ₖ, k=1, 2, . . . , I) between the target input data (indicated by the symbol “a”) and the template (indicated by the symbol “b”) is calculated as follows:

$$D ( Φ ( 0 ) = \{ {\sum }_{j = 1}^{N} \vert {log ( Φ ( 0 ) )}_{j}^{a} - log ( {( Φ ( 0 ) )}_{j}^{b} \vert \} / N \qquad ( 11 )$$

The formula (11) obtains a distance that relates to Φ (0), in which N expresses the number of analysis frames. The calculation is performed in a logarithmic form because human auditory perception has a logarithmic sensitivity to physical quantities. The distances of other independent factors are also obtained with the same formula.

A sum D of the distances is expressed by the following formula in which the distance D (x) of each factor is added.

$$D = {\sum }_{X = 1}^{M} {W}^{X} D ( X ) \qquad ( 12 )$$

In the formula (12), M is the number of factors and W is a weight coefficient. The template for which the calculated distance D is smallest is judged to be the syllable of the input signal. As will be explained below, highly accurate recognition is possible in actual sound fields by adding IACF factors when D is obtained. In this case, D (x) is calculated in accordance to the formula (11) for the IACF factors IACC, τ_{IACC}, and W_{IACC} and added to the formula (12).

As described above, with the present embodiment, since the value Φ (0) when the delay time of the ACF is 0, the delay time τ₁ and the amplitude φ₁ of the first peak of the ACF, and the effective duration time τₑ of the ACF are extracted from the speech signal, it is possible to obtain the size of the sound from the Φ (0) of the extracted ACF, and it is also possible to obtain the speech pitch (sound pitch) and the intensity of that pitch from the delay time τ₁ and the amplitude φ₁ of the first peak of the ACF. Furthermore, consideration can be given to the influence of noise and reverberation in actual sound fields with the effective duration time τₑ of the ACF.

In this way, with the present embodiment, since it is possible to extract speech characteristics using four parameters that correspond to human auditory perceptiveness, it is possible to achieve a speech recognition device based on an extremely simple configuration compared to conventional devices and without the need to perform spectral analysis.

Moreover, since the local peaks that appear up to the first peak of the ACF of the speech signal are also extracted with the present embodiment, it is also possible to specify the timbre of the speech from those local peaks.

And since the maximum value IACC of the IACF, the peak delay time τ_{IACC} of the IACF, and the width W_{IACC} of the maximum amplitude of the IACF of the speech signal are also extracted with the present embodiment, it is possible to obtain a sense of subjective expanse from the maximum value IACC of that IACF and also possible to obtain a perception of the horizontal direction of the sound source from the delay time τ_{IACC} of a peak of the IACF. Moreover, it is also possible to obtain a perceived apparent source width (ASW) from the maximum value IACC of the IACF and the width W_{IACC} of the maximum amplitude of the IACF.

Accordingly, by including these IACF factors, that is, spatial information of the actual sound field, with speech recognition, it is possible to achieve highly accurate recognition that reflects human perception in actual sound fields.

It should be noted that, in the above-described embodiment, the value Φ (0) when the delay time of the ACF is 0 is extracted as information related to the size of a sound, but instead of this it is also possible to extract the value Φ (0) when the delay time of the IACF is 0 and use this for recognition.

In the above-described embodiment, ACF factors and IACF factors are both extracted, but the present invention is not limited to this, and it is possible to extract only ACF factors. When extracting only ACF factors, it is possible to use a binaural microphone for collecting speech signals, and it is also possible to use a monaural microphone.

In the embodiment shown in FIG. 2, a functional block diagram is used to show a hardware configuration of the speech recognition device of the present invention, but the present invention is not limited to this, and it is also possible to achieve the speech recognition method of the present invention by, for example, storing the speech recognition program for performing speech recognition processing shown in FIG. 3 on a computer readable storage medium such as a personal computer and executing the stored program on a computer.

Furthermore, it is also possible to achieve the speech characteristic extraction method of the present invention by storing the speech characteristic extraction program for performing speech characteristic extraction processes of step S1 to step S5 in FIG. 3 on a storage medium readable by a computer such as a personal computer and executing the stored program on a computer.

A memory, such as a ROM, accommodated in a computer may be used as the computer readable storage medium, and it is also possible to use a readable storage device enabled by a reading device (external storage device) set up with a computer, examples of these being tape systems such as magnetic tapes and cassette tapes, magnetic disc systems such as floppy disks and hard disks, optical disk systems such as CD-ROMs, MOs, MDs, and DVDs, card systems such as IC cards (including memory cards) and optical cards, and it is also possible to use semiconductor memories such as mask ROMs, EPROMs, EEPROMs, and flash ROMs as the storage medium.

Working Examples

The results of estimating speech articulation in an actual sound field will be shown as a working example that shows the specific operation of the device shown in FIG. 2.

In this working example, a test was conducted in which a monosyllable of a target sound was presented from in front of a subject and, at the same time, white noise, or a different monosyllable, was presented from the side of the subject as an interference sound, and the subject had to answer concerning the target sound. Articulation is expressed as the rate of correct answers by the subject. It, should be noted that 30°, 60°, 120°, and 180° were used as the angles at which interference sounds were presented.

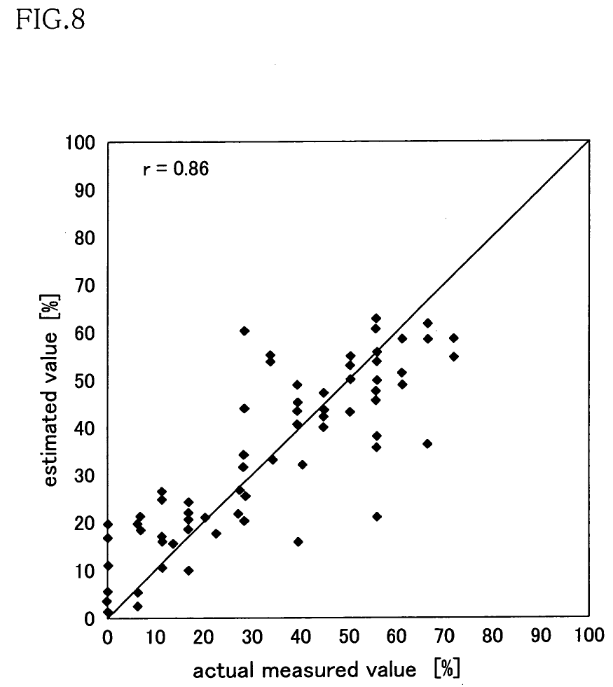

ACF factors and IACF factors when only the target sounds were presented were stored in templates (a database) in order to estimate articulation, and the distance of each of the factors under the test conditions were obtained with the device shown in FIG. 2. The results (actual measured values) and the estimated values are shown in FIG. 8. It should be noted that the estimated values are values that do not include τ′ₖ and φ′ₖ, which are the delay time and the amplitude of local peaks of the normalized ACF, as factors to obtain the distance D by the formula (12).

It is evident from FIG. 8 that the actual test results of the working example are extremely close (estimation rate r=0.86) to the values estimated by calculation, and that it is possible to achieve recognition that reflects human perception in actual sound fields by including spatial information of the sound field. Furthermore, it is evident that estimation is possible even in poor conditions, such as many strong interference sounds being present in the sound field, by using the device shown in FIG. 2.

Industrial Applicability

As described above, the speech characteristic extraction method and speech characteristic extraction device, as well as the speech recognition method and speech recognition device of the present invention are able to achieve speech recognition in environments where speech recognition is actually used, including indoor areas such as houses, offices, and meeting rooms, and outdoor areas such as inside cars, train stations, and roadside areas, and is able to solve the problem robustness in such environments. With the present invention, it is possible to achieve highly accurate speech recognition that reflects human perception, and is therefore useful and beneficial.

1. A speech characteristic extraction method that extracts a speech characteristic required for speech recognition, wherein an autocorrelation function of a speech signal is determined, and a value Φ (0) of when a delay time of the autocorrelation function is 0, a delay time τ₁ and an amplitude φ₁ of a first peak of the autocorrelation function, and an effective duration time τₑ of the autocorrelation function are extracted from the autocorrelation function.

2. A speech characteristic extraction device that extracts a speech characteristic required for speech recognition, comprising:
a microphone;
a computing means for determining an autocorrelation function of a speech signal collected by the microphone; and
an extraction means for extracting from the autocorrelation function a value Φ (0) of when a delay time of the autocorrelation function is 0, a delay time τ₁ and an amplitude φ₁ of a first peak of the autocorrelation function, and an effective duration time τₑ of the autocorrelation function.

3. A speech characteristic extraction method according to claim 1, or a speech characteristic extraction device, wherein local peaks up to a first peak of the autocorrelation function are extracted.

4. A speech recognition method, wherein data extracted by the speech characteristic extraction method according to claim 1, namely a value Φ (0) of when a delay time of the autocorrelation function is 0, a delay time τ₁ and an amplitude φ₁ of a first peak of the autocorrelation function, and an effective duration time τₑ of the autocorrelation function, are compared to a template for speech recognition to achieve speech recognition.

5. A speech recognition device, comprising:
the speech characteristic extraction device according to claim 2; and
a recognition means for recognizing a speech, wherein data extracted by the speech extraction device, namely a value Φ (0) of when a delay time of the autocorrelation function is 0, a delay time τ₁ and an amplitude φ₁ of a first peak of the autocorrelation function, and an effective duration time τₑ of the autocorrelation function, are compared to a template for speech recognition to achieve speech recognition.

6. A speech recognition method according to claim 4, or a speech recognition device, wherein local peaks up to a first peak of the autocorrelation function are extracted, and data including the local peaks are compared to a template to achieve speech recognition.

7. A speech characteristic extraction method that extracts a speech characteristic required for speech recognition, wherein:
an autocorrelation function and an interaural crosscorrelation function of a binaurally measured speech signal are respectively determined, and a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function of the speech signal, and a value Φ (0) of when a delay time of the autocorrelation function or the interaural crosscorrelation function is 0, are extracted from the autocorrelation function and the interaural crosscorrelation function.

8. A speech characteristic extraction device that extracts a speech characteristic required for speech recognition, comprising:
a binaural microphone;
a computing means for respectively determining an autocorrelation function and an interaural crosscorrelation function of a speech signal collected by the microphone; and
an extraction means for extracting from the autocorrelation function and the interaural crosscorrelation function a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function, and a value Φ (0) of when a delay time of the autocorrelation function, or the interaural crosscorrelation function, is 0, are extracted.

9. A speech characteristic extraction method according to claim 7, or a speech characteristic extraction device, wherein local peaks up to a first peak of the autocorrelation function are extracted.

10. A speech recognition method wherein data extracted by the speech characteristic extraction method according to claim 7, namely a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function of the speech signal, and a value Φ (0) of when a delay time of the autocorrelation function or the interaural crosscorrelation function is 0, are compared to a template for speech recognition to achieve speech recognition.

11. A speech recognition device, comprising:
the speech characteristic extraction device according to claim 8; and
a recognition means for recognizing a speech, wherein data extracted by the speech extraction device, namely a delay time τ₁ and an amplitude φ₁ of a first peak of the autocorrelation function, an effective duration time τₑ of the autocorrelation function, a maximum value IACC of the interaural crosscorrelation function, a delay time τ_{IACC} of a peak of the interaural crosscorrelation function, a width W_{IACC} of a maximum amplitude of the interaural crosscorrelation function, and a value Φ (0) of when a delay time of the autocorrelation function or the interaural crosscorrelation function is 0, are compared to a template for speech recognition to achieve speech recognition.

12. A speech recognition method according to claim 10, or a speech recognition device, wherein local peaks up to a first peak of the autocorrelation function are extracted, and data including the local peaks are compared to a template to achieve speech recognition.
